(19) United States
(12) Patent Application Publication
(10) Pub. No.: US 2025/0389629 A1
(43) Pub. Date: Dec. 25, 2025

(54) Laser-Based High Temperature Material Characterization Method

(71) Applicant: The Government of the United States of America, as represented by the Secretary of the Navy, Arlington, VA (US)

(72) Inventors: Christopher Rudolf, Washington, DC (US); Maurizio Manzo, Fort Worth, TX (US)

(73) Assignee: The Government of the United States of America, as represented by the Secretary of the Navy, Arlington, VA (US)

(21) Appl. No.: 19/235,800

(22) Filed: Jun. 12, 2025

Related U.S. Application Data
(60) Provisional application No. 63/663,978, filed on Jun. 25, 2024.

(51) Int. Cl. G01N 3/18

(52) U.S. Cl. CPC G01N 3/18; G01N 2203/0075; G01N 2203/0226; G01N 2203/0641

(57) ABSTRACT

A method of laser-based high temperature mechanical property characterization comprising the steps of providing a mechanical test frame and chamber, loading a specimen in the mechanical test frame in the chamber, providing a laser, aligning the laser, sealing the chamber, evacuating 5 the chamber and optionally backfilling with a prescribed atmosphere, turning on the laser, applying mechanical loading to the specimen in the mechanical test frame, utilizing a load cell and a non-contact video extensometer, synchronizing the output of the load cell and non-contact video extensometer, and tracking the strain in the specimen. A device for laser-based high temperature mechanical property characterization comprising a vacuum chamber with a laser 10 transmissible window and viewing window, a vacuum pump, a uniaxial tensile system inside the vacuum chamber, a thermocouple inside the vacuum chamber, laser optics inside the vacuum chamber, a function generator, a laser source, an IR camera, and a video camera.

### REFERENCE TO RELATED APPLICATION

This application is a non-provisional of, and claims priority to and the benefits of, U.S. Provisional Patent Application No. 63/663,978 filed on Jun. 25, 2024, the entirety of which is herein incorporated by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; techtran@nrl.navy.mil, referencing Navy Case #211722.

### BACKGROUND

This disclosure concerns a new apparatus and new experimental method that utilizes a laser for heating specimens under mechanical deformation tests for thermo- mechanical characterization.

The invention allows 1) rapid and non-contact heating to high temperatures; 2) testing in prescribed atmospheric conditions; and 3) homogeneous or controlled thermal gradients/heat fluxes in the specimen.

This disclosure pertains to emerging applications that require high temperature materials that can operate above 1000° C. These applications are becoming more prevalent, such us hypersonic and supersonic aircraft, anti-terrorist measures, welding technologies, space exploration, and many others.

Because significant changes occur in the thermal and mechanical properties of materials at elevated temperatures, novel methods are required to obtain material properties at said temperatures and potentially under oxidizing environments.

However, mechanical property testing at elevated temperatures is non-trivial and it is necessary to properly control and characterize the temperature profiles, strain, and loading. Because significant changes occur in the microstructure and mechanical properties of materials at elevated temperatures, models are often needed to describe the thermomechanical response. Unfortunately, existing experimental methods of performing high temperature mechanical deformation to supply model parameters either inhibit non-contact strain measurement or have slow heating rates, which allows microstructure (e.g., grain growth), mechanical property (e.g., temperature induced creep), or phase changes prior to testing. The rapid heating rates made possible using laser irradiation significantly limit these unwanted, time-dependent changes, which allows for a material's performance to be known under certain extreme environments. These experimental values are essential for increasing the accuracy of and validating the models.

Current methods for thermo-mechanical testing include using a furnace/environmental chamber, induction heating, and Joule heating. Regardless of the technique used, the experimental setup should be able to provide a controllable heat distribution over a designated cross-section of the specimen being tested and should allow access for temperature and strain measurement. One of the main factors leading to poor heat distribution is the gripping method. For example, if a furnace is used to heat the specimen, the grips are typically located outside of the furnace because they are not rated for high temperature use. As a means of reducing the heat absorbed by the grips, a three-zone furnace can be implemented without producing large nonlocalized thermal gradients on the specimen. Furnaces can achieve uniform, very high temperatures but heating in an air environment is limited to about 1700° C. due to the heating elements oxidizing. Their use, however, is further limited because chamber heating and cooling occurs at a significantly slower rate (5-50° C./min) than what would occur in the actual environment being simulated (e.g., 100 s° C./second possible for hypersonics). During this process of heating and cooling, it is possible that strains may set in the material prior to testing and increased oxidation and creep could occur. The aim is to test the specimen under realistic heating conditions and observe any changes in material properties and/or structure.

Induction and Joule heating can provide for very rapid heating and cooling rates and have the added capability of heating the specimen without directly heating the grips. Unfortunately, these methods require the specimen to be conductive and therefore limits what can be tested. With induction heating, visibility to the specimen is impeded and makes it difficult to track strain. Joule heating provides greater accessibility to the specimen but producing uniform current densities, stress, and strain profiles is difficult.

This invention solves these long-standing problems.

This invention utilizes a laser to focus the specimen heating in the area of interest. Because the laser source can be external to the mechanical testing chamber, ample visibility of the sample is available for strain tracking and thermal profile characterization via external monitors.

Additionally, the laser source can be swapped out to tailor the source wavelength to the absorption wavelength of the material of interest.

The mechanical deformations are provided by a small-scale mechanical test frame that is located inside a chamber. The chamber is fully sealed and can be placed under vacuum or filled with a prescribed atmosphere for simulating an operational environment.

The laser beam can impart energy on a single side of the specimen for creating through-thickness thermal gradients or split and imparted on both the top and bottom surfaces for controlling and homogenizing the temperature profile.

Additionally, beam scanning can be utilized to heat a larger gauge section of the sample or additional optics can be utilized to create a flat-top beam that would result in a larger area of the gauge section having a uniform temperature.

Herein, we demonstrate a solution to the current long-standing problems with high temperature mechanical property characterization.

### SUMMARY OF DISCLOSURE

### Description

This disclosure concerns a new apparatus and new experimental method for laser- based high temperature mechanical property characterization.

This invention utilizes a laser for heating specimens under mechanical deformation tests for thermo-mechanical characterization.

The invention allows 1) rapid and non-contact heating to high temperatures; 2) testing in prescribed atmospheric conditions; and 3) homogeneous or controlled thermal gradients/heat fluxes in the specimen.

### DESCRIPTION OF THE DRAWINGS

The following description and drawings set forth certain illustrative implementations of the disclosure in detail, which are indicative of several exemplary ways in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

FIG. 1 illustrates a schematic and image of an experimental setup.

FIG. 2 illustrates equipment inside the vacuum chamber.

FIG. 3 illustrates load and strain as functions of time: Cu at 18 W laser output.

FIG. 4 illustrates top and bottom surface temperature as functions of time: Cu at 18 W laser output.

FIG. 5 illustrates the temperature profile as a function of specimen gauge length area captured by FLIR camera: Ti3SIC2 at 40 W laser output.

### DETAILED DESCRIPTION OF THE INVENTION

This disclosure teaches methods and devices for a new apparatus and new experimental method for laser-based high temperature mechanical property characterization.

This invention utilizes a laser for heating specimens under mechanical deformation tests for thermo-mechanical characterization.

The invention allows 1) rapid heating to high temperatures; 2) testing in prescribed atmospheric conditions; and 3) homogeneous or controlled thermal gradients/heat fluxes in the specimen.

Herein, we demonstrate a solution to the current long-standing problems with high temperature mechanical property characterization.

The typical invention consists of a laser source, a mechanical test frame, a chamber, an optical temperature measurement device, and a video extensometer for strain tracking, and a data acquisition system.

### Example 1

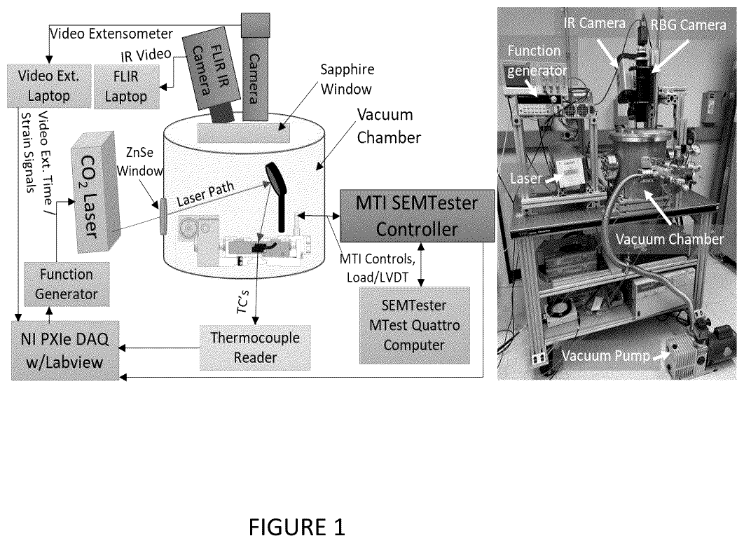

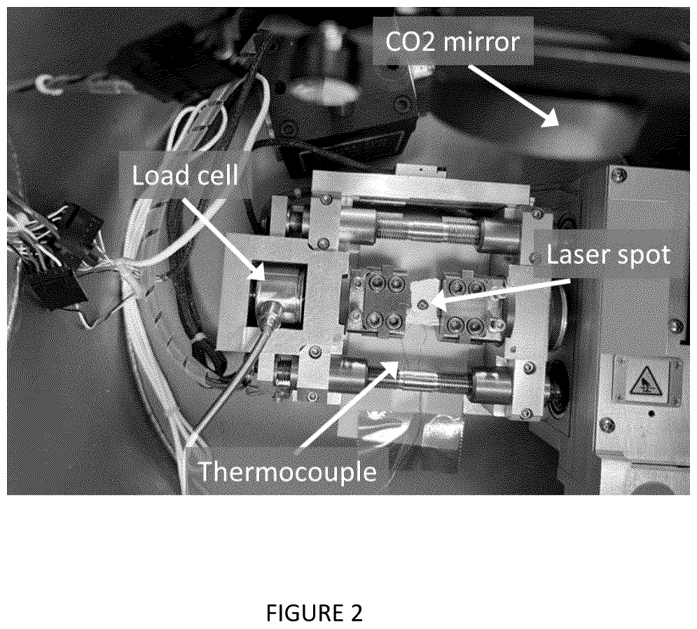

A prototype of the invention is shown in FIG. 1 and FIG. 2.

A SEMTester 2000 EBSD with a 8900 N load cell is used for uniaxial tensile deformation.

A CO2 mirror is used to direct the laser beam onto the specimen.

A k-type thermocouple is placed in contact with the back side of the sample under the region hit by the laser, allowing for the temperature gradient across the sample thickness to be calculated.

As shown in FIG. 2, alignment of the laser spot is performed using an IR sensitive paper to ensure heating to the center of the specimen gauge length.

Finally, an IR camera (FLIR, operating in the 3-5 μm spectral band), calibrated for 2000° C. max temperature is used to map the surface temperature of the specimen.

Importantly, the FLIR operating on the 3-5 μm spectrum results in the camera being “blind” to the wavelength of the CO2 laser.

The ability to rapidly heat a localized area on the specimen gauge length removes the issues and limitations that other high temperature testing methods inherently have. This method is capable of generating large thermal gradients (flux) through specimen thickness for testing a range of materials that may experience thermal shock under normal operating environments or could result in a prescribed or homogeneous temperature gradient via beam splitting and heating from both the top and bottom of the specimen.

### Example 2

DIC and IR thermography are employed to determine strain and temperature distributions in the specimens under test.

A thermocouple is used to monitor the back-side temperature of the specimen, while the other side of the specimen is heated by the laser beam (spot size 4 mm in diameter) at the center of the specimen gauge length.

### Example 3

A steel vacuum chamber connected to a hydraulic pump was used to host the uniaxial tensile system, thermocouples, and a CO2 laser mirror, as illustrated in FIG. 2.

Outside the chamber a function generator is used to drive a 50-watt CO2 laser.

The laser beam (Gaussian profile) passes across a 2-inch window, which is mounted on the left side of the vacuum chamber and is 99% transparent for the IR wavelengths.

There are ports on the chamber that allow passthrough for the cabling to control the mechanical test system as well as thermocouples and additional view windows for illuminating the sample and allowing for the IR and video cameras to view the sample for non-contact temperature and strain measurements.

Inside the chamber, a CO2 mirror is used to direct the laser beam into the specimen gauge section.

The IR camera is calibrated for temperature measurements up to 2,000° C.

In some embodiments, a ZnSe window is used, in other embodiments a different window is used, based on the laser wavelength in use.

In some embodiments, a CO2 laser mirror is used, in other embodiments a different mirror is used, based on the laser wavelength in use.

In some embodiments, equilibrium temperature of the specimen is achieved for 15-20 secs, in other embodiments equilibrium temperature of the specimen is achieved for various times based on the thermal properties of the specimen's material.

In some embodiments, the IR camera is calibrated for temperature measurements greater than 2,000° C.

### Example 4

The method begins by loading a specimen in the mechanical test frame.

The laser is then aligned to the center of the gauge section via adjustments to the mirror.

Once aligned, the chamber lid is put in place and the chamber is evacuated (and re-filled with a prescribed atmosphere, if applicable).

The laser is turned on and the temperature is monitored via a FLIR camera.

The specimen temperature is allowed to come to equilibrium (about 15-20 seconds) before mechanical loading begins.

The output of the load cell and non-contact video extensometer are synchronized in the data acquisition system for accurate stress-strain measurements.

The strain is tracked by following painted speckle pattern points, inclusions in the specimen, or machined grooves.

### Example 5

### Laser absorption in metals

When light hits the metal's surface, some is absorbed in the material and some is reflected. In metals, optical absorption is dominated by the free electrons.

The absorptivity of the material depends on the frequency of the light source and the angle of incidence.

Moreover, the absorptivity depends on the temperature of the material.

The absorbed light intensity decays exponentially with depth, based on the material's absorption coefficient, following the Beer-Lambert law. Typically, metals have higher reflectivity and low absorption at long wavelengths. Based on the type of laser source, there can be several (non-linear) effects.

However, while non-linear effects are possible and may reduce the laser energy absorption depth, CW lasers primarily incite single photon interactions in a material, allowing for maximum penetration depth.

### Example 6

Proof of concept tensile testing was performed on dogbone specimens of pure copper and aluminum.

The stress-strain curve accuracy provided validation for the apparatus and method.

Dogbone specimens with gauge length of 15 mm, width of 2.5 mm, and thickness of 1 mm were prepared using wire EDM machining from 99.99% pure copper and aluminum sheets.

Due to the high reflectivity of metals in the IR region of the spectrum as mentioned earlier, the specimens were coated with a thin layer of graphite spray.

Graphite is highly absorbent in the infrared region and also provides a higher emissivity (0.89 measured experimentally), which provides more accurate temperature measurement via the FLIR camera.

Prior to coating, the surface was treated with sandpaper, to increase roughness, which helped diminish specular laser reflections.

MAX-phase specimens (Ti₃SiC₂) were prepared for test by wire EDM into dogbone shapes with gauge length of 10 mm, width of 2.5 mm, and thickness of 1 mm.

Due to the lower reflectivity in the IR region, measured using FTIR, the specimen was not coated.

Post-test characterization of the specimens was carried out via scanning electron microscopy.

### Example 7

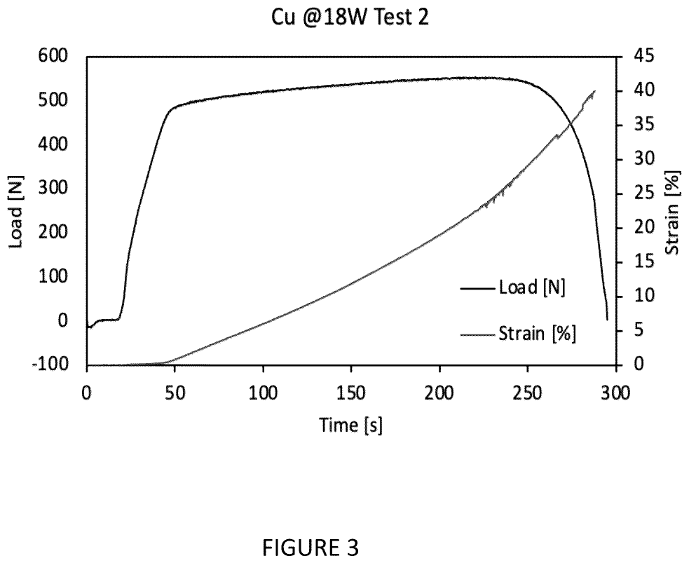

FIG. 3 shows the load and strain curves as a function of time for the Cu specimen.

As shown in the figure, the peak load was 545 N, while the strain at the fracture was 40%.

The fracture occurred in the region with the highest temperature, corresponding to the center of the laser beam (gaussian shape).

### Example 8

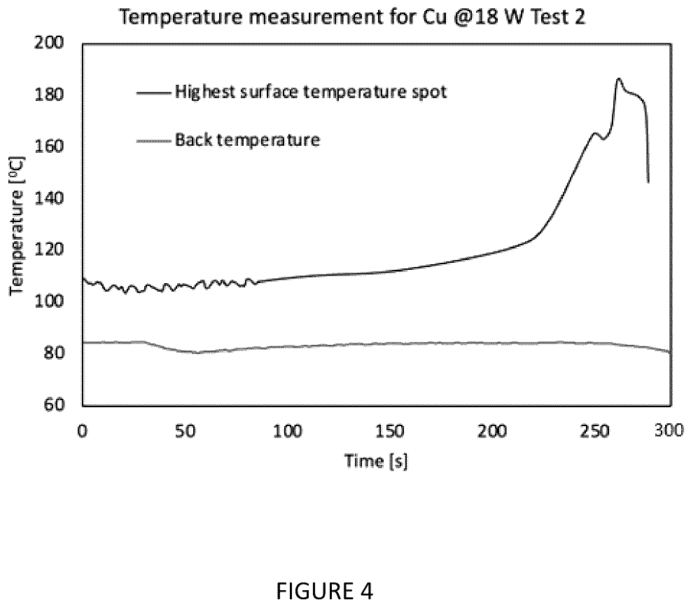

FIG. 4 shows the peak surface temperature captured by the FLIR camera and the back temperature captured by the thermocouple as a function of time.

The initial difference between the two was 24.5° C. FIG. 4 demonstrates a temperature fluctuation (both surface and back sides of the specimen). This was determined to be due to an aging laser source that caused variation in the laser intensity during the test. The rapid uptick of the temperature towards the end of the test is resultant from the necking formation which reduces the cross-sectional area of the specimen, increasing the temperature.

### Example 9

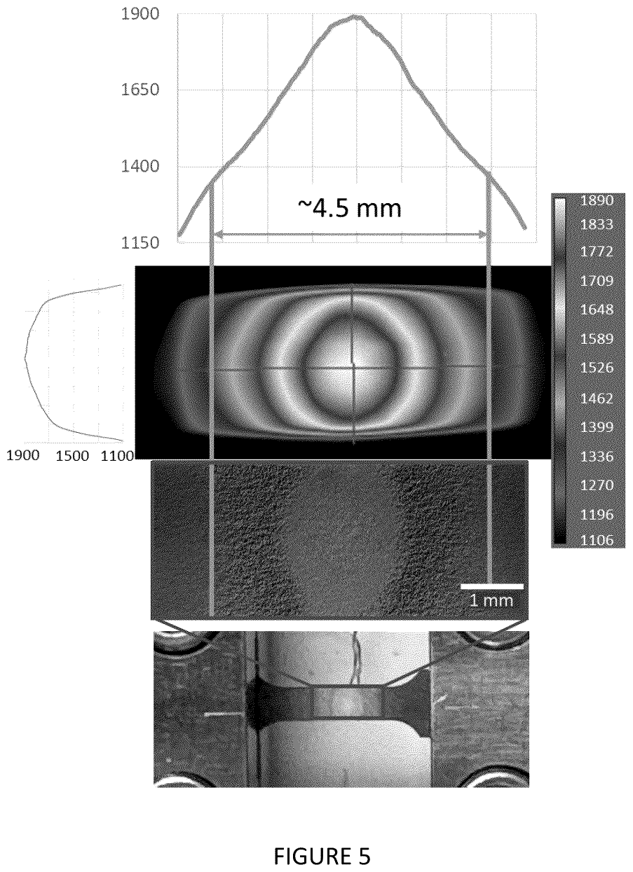

FIG. 5 shows the temperature profile of a Ti3SIC2 sample at a 40 Watt output from the CO2 laser captured by the FLIR camera.

This figure illustrates the capability of this setup to achieve temperatures >1750° C. when the wavelength of the laser source is matched for the absorptivity wavelength of the material being tested. The temperature profile illustrates the localization of the heating to the specimen's gauge section.

### Advantages and New Features

Our invention can perform mechanical deformation in tensile, compression, and bending by swapping out the load stage grips.

Additionally, the laser source can be swapped out to tailor the source wavelength to the absorption wavelength of the material of interest.

The laser beam can impart energy on a single side of the specimen for creating through-thickness heat fluxes or be split and imparted on both the top and bottom surfaces for controlling and homogenizing the temperature profile.

For testing of materials that may experience extreme thermal fluxes/gradients or thermal shock (e.g., hypersonics), active cooling to the back-side of the specimen (e.g., via liquid-nitrogen) can be utilized to provide extreme thermal gradients.

Additionally, beam scanning can be utilized to heat a larger gauge section of the sample. Moreover, a non-Gaussian laser beam can be used to provide a more uniform heating of the specimen, based on its size.

This invention enables high temperature thermo-mechanical testing of materials by selectively, and rapidly, heating the specimen, which solves long-standing problems in the art.

This reduces the drawbacks, and solves the problems, of other high temperature test methodologies such as grip heating, slow heating rates, and oxidation, which inherently affect the result accuracy.

This system also allows grip swapping for different types of mechanical deformation (tensile, compression, bending).

The laser beam can impart energy on a single side of the specimen for creating through-thickness heat fluxes or be split and imparted on both the top and bottom surfaces for controlling and homogenizing the temperature profile.

This is the first known apparatus that can simultaneously perform rapid, directed heating, controlled thermal profiles and fluxes, mechanical deformation, stress-strain measurements, all inside a prescribed environment.

Additionally, the small specimen sizes that this system utilizes (e.g., tensile dogbones with a 5-15 mm gauge section) enables mechanical testing for R&D when only a small amount of material is available.

The above examples are merely illustrative of several possible embodiments of various aspects of the present disclosure, wherein equivalent alterations and/or modifications will occur to others skilled in the art upon reading and understanding this specification and the annexed drawings. In addition, although a particular feature of the disclosure may have been illustrated and/or described with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising”.

What we claim is:

1. A method of laser-based high temperature mechanical property characterization, comprising the steps of:
providing a mechanical test frame and chamber;
loading a specimen in the mechanical test frame in the chamber;
providing a laser;
aligning the laser;
sealing the chamber;
evacuating the chamber;
turning on the laser;
applying mechanical loading to the specimen in the mechanical test frame;
utilizing a load cell and a non-contact video extensometer;
synchronizing the output of the load cell and the non-contact video extensometer; and
tracking the strain in the specimen.

2. The method of laser-based high temperature mechanical property characterization of claim 1, further comprising the steps of:
providing a thermocouple in contact with the specimen in the mechanical test frame in the chamber.

3. The method of laser-based high temperature mechanical property characterization of claim 2, further comprising the steps of:
heating via the laser a first portion of the specimen;
measuring temperature and rate of change of the specimen in the mechanical test frame in the chamber; and
measuring temperature gradient of the specimen in the mechanical test frame in the chamber.

4. The method of laser-based high temperature mechanical property characterization of claim 3, further comprising the steps of:
synchronizing the output of the load cell and the non-contact extensometer in a data acquisition system for stress-strain measurements.

5. The method of laser-based high temperature mechanical property characterization of claim 4, further comprising the steps of:
providing a mirror; and
utilizing adjustments to the mirror to align the laser beam.

6. The method of laser-based high temperature mechanical property characterization of claim 5, further comprising the steps of:
providing a beam splitter and additional mirrors; and
utilizing adjustments to the mirrors to align the laser beam to heat from top and bottom of the specimen.

7. The method of laser-based high temperature mechanical property characterization of claim 4, further comprising the steps of:
cooling a second portion of the specimen; and
tracking the strain in the specimen in the mechanical test frame in the chamber by following painted speckle pattern points, inclusions in the specimen, or machined grooves.

8. The method of laser-based high temperature mechanical property characterization of claim 7, further comprising the steps of:
re-filling the chamber with a prescribed atmosphere after the step of evacuating the chamber.

9. The method of laser-based high temperature mechanical property characterization of claim 8, further comprising the steps of:
utilizing an IR camera to monitor the temperature.

10. The method of laser-based high temperature mechanical property characterization of claim 9, further comprising the steps of:
achieving equilibrium temperature of the specimen prior to the step of
applying mechanical loading to the specimen in the mechanical test frame.

11. A device for laser-based high temperature mechanical property characterization, comprising:
a vacuum chamber with a window;
a vacuum pump connected to the vacuum chamber;
a uniaxial tensile system inside the vacuum chamber;
a thermocouple inside the vacuum chamber;
a set of laser optics inside the vacuum chamber;
a function generator;
a laser source;
an IR camera; and
a video camera.

12. The device for laser-based high temperature mechanical property characterization of claim 11,
wherein the function generator drives a 50-watt CO2 laser.

13. The device for laser-based high temperature mechanical property characterization of claim 12,
wherein the ZnSe window is 99% transparent for the IR wavelengths.

14. The device for laser-based high temperature mechanical property characterization of claim 13,
wherein the IR camera and the video camera are outside the steel vacuum chamber; and
wherein the IR camera and the video camera can view the sample for non-contact temperature and strain measurements.

15. The device for laser-based high temperature mechanical property characterization of claim 14,
wherein the CO2 mirror directs the laser into the specimen.

16. The device for laser-based high temperature mechanical property characterization of claim 15,
wherein the IR camera is calibrated for temperature measurements up to 2,000° C.
